(19) United States
(12) Patent Application Publication
(10) Pub. No.: US 2026/0044196 A1
(43) Pub. Date: Feb. 12, 2026

(54) DEFINING AND USING ENERGY CONSUMPTION POINTS

(71) Applicant: NOKIA SOLUTIONS AND NETWORKS OY, Espoo (FI)

(72) Inventors: Grzegorz Ciolkowski, Kuraszkow (PL); Kari Tapani Turpeinen, Wroclaw (PL); Marek Michalak, Malin (PL); Pawel Koch, Wroclaw (PL)

(21) Appl. No.: 18/997,712

(22) PCT Filed: Jun. 30, 2023
(86) PCT No.: PCT/EP2023/068037

§ 371 Date: Jan. 22, 2025

Related U.S. Application Data
(60) Provisional application No. 63/392,172, filed on Jul. 26, 2022.

(51) Int. Cl. G06F 1/3206; G06F 1/3296

(52) U.S. Cl. CPC G06F 1/3206; G06F 1/3296

(57) ABSTRACT

A mapping is determined from one or more of multiple components in a device to an energy consumption point (ECP). One or both of the following are performed: in response to input indicating component(s) of the ECP is to be placed into energy saving mode, switching autonomously by the device the ECP into an associated energy saving mode for additional energy saving gain relative to only if the component(s) are switched into energy saving modes, the switching autonomously based at least on the mapping; or in response to input indicating the ECP should be placed into an energy saving mode, switching by the device individual ones of the determined component(s) into associated energy saving modes.

### TECHNICAL FIELD

Exemplary embodiments herein relate generally to devices used in communication systems and, more specifically, relates to power savings in those devices.

### BACKGROUND

Devices, particularly battery-powered devices, often have power saving modes. For instance, devices that connect with wireless networks such as cellular networks will periodically enter power saving modes in order to save battery power, while still providing the ability for wireless communication.

As an example, DRX (discontinuous reception) is one of multiple methods used to help a UE (User Equipment, a wireless device that connects to a network) reduce power. During DRX, the UE takes certain steps such as turning off a transceiver, which lowers power.

As another example, consider base station transceiver units. These devices typically operate with high powers and consume massive amount of energy. It is then important to make sure that configuration of such a device is optimal from power saving perspective, i.e., that power saving is applied as often as possible and as efficiently as possible.

The process of reducing energy consumption for devices such as these, and others, can be improved.

### BRIEF SUMMARY

This section is intended to include examples and is not intended to be limiting.

In an exemplary embodiment, a method is disclosed that includes determining a mapping from one or more of multiple components in a device to an energy consumption point. The method includes performing one or both of the following: in response to input indicating one or more components of the energy consumption point is to be placed into energy saving mode, switching autonomously by the device the energy consumption point into an associated energy saving mode for additional energy saving gain relative to only if the one or more components are switched into energy saving modes, the switching autonomously based at least on the mapping; or in response to input indicating the energy consumption point should be placed into an energy saving mode, switching by the device individual ones of the determined one or more components into associated energy saving modes.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus at least to: determine a mapping from one or more of multiple components in a device to an energy consumption point; perform one or both of the following: in response to input indicating one or more components of the energy consumption point is to be placed into energy saving mode, switch autonomously by the device the energy consumption point into an associated energy saving mode for additional energy saving gain relative to only if the one or more components are switched into energy saving modes, the switching autonomously based at least on the mapping; or in response to input indicating the energy consumption point should be placed into an energy saving mode, switch by the device individual ones of the determined one or more components into associated energy saving modes.

An exemplary computer program product includes a computer-readable storage medium bearing computer program code embodied therein for use with a computer. The computer program code includes: code for determining a mapping from one or more of multiple components in a device to an energy consumption point; code for performing one or both of the following: in response to input indicating one or more components of the energy consumption point is to be placed into energy saving mode, switching autonomously by the device the energy consumption point into an associated energy saving mode for additional energy saving gain relative to only if the one or more components are switched into energy saving modes, the switching autonomously based at least on the mapping; or in response to input indicating the energy consumption point should be placed into an energy saving mode, switching by the device individual ones of the determined one or more components into associated energy saving modes.

In another exemplary embodiment, an apparatus comprises means for performing: determining a mapping from one or more of multiple components in a device to an energy consumption point; performing one or both of the following: in response to input indicating one or more components of the energy consumption point is to be placed into energy saving mode, switching autonomously by the device the energy consumption point into an associated energy saving mode for additional energy saving gain relative to only if the one or more components are switched into energy saving modes, the switching autonomously based at least on the mapping; or in response to input indicating the energy consumption point should be placed into an energy saving mode, switching by the device individual ones of the determined one or more components into associated energy saving modes.

### BRIEF DESCRIPTION OF THE DRAWINGS

In the attached Drawing Figures:

FIG. 1 illustrates a device having three energy consumption points within the device that is composed of six components, in accordance with an exemplary embodiment;

FIG. 2 is a logic flow diagram for defining and using energy consumption points, and illustrates the operation of an exemplary method or methods, a result of execution of computer program instructions embodied on a computer readable memory, functions performed by logic implemented in hardware, and/or interconnected means for performing functions in accordance with exemplary embodiments;

FIG. 2A is a logic flow diagram for part of FIG. 2, in accordance with an exemplary embodiment; and

FIG. 3 is a block diagram of an apparatus in which the exemplary embodiments may be practiced.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

A device, such as a wireless device, is composed of number of components. A component is visible for a user and can be configured by the user to perform a specific function, and is an embodiment that can be controlled in the aspects of its power consumption. A component can be a physical entity or a logical entity. That is, a component abstracts a physical entity (so related directly to underlying hardware) or a logical entity (so incorporates a higher layer such as hardware and some vendor-specific invisible and non-controllable logic) that forms an entity that can serve a function for customer.

A device is also composed of HW (hardware) elements (e.g., a power supply unit, power amplifiers, processing units, antennas), which are not visible or configurable to the user but act as a base for the components. A device is a highest-level embodiment based on hardware or part of hardware, grouping at least one ECP. The device may additionally (though not must) also group one or more components.

Components might be grouped through HW elements or power dependencies. For instance, several components may be served by one HW element or a set (two or more) of HW elements.

From an energy-saving perspective, if components related to specific HW element(s) are not performing any function or are switched to an energy saving mode by the user, the device can autonomously switch that HW element to an energy saving mode, for additional reduction of energy consumed by device.

An energy saving mode is a state of a HW element or a component. When a HW element or a component is switched to this mode, the energy consumption of the device is reduced. Switching to an energy saving mode may include but is not limited to actions such as the following: switching off the HW element; reducing energy consumption by HW element; stopping or de-configuring the function of the component; switching the component to operate with reduced capability or performance.

It is highly beneficial for the user to know about such dependencies to perform configuration and management of the device in power efficient way, such as in a way that maximizes possibilities and chances of the device reducing energy consumption by switching its HW elements into corresponding energy saving modes.

However, vendors may not want to expose the HW architecture or exact HW elements to the user. That is, the vendors of device might not want the user to be able to directly control the HW.

The examples herein aim to solve, as one benefit, this conflict of interest between vendors and users. As an overview, the exemplary embodiments herein introduce a possibility for the device to expose information about dependencies between components, or between components and HW elements, within device to the user without exposing the actual HW architecture (such as structure or amount of HW elements). To enable this, a logical component, the energy consumption point, is introduced, which can be used to expose such dependencies. This information can be used by a user to configure a device in a power efficient way. More detail is provided now.

Concerning the logical component referred to herein as an Energy Consumption Point (ECP), consider the following. Through a model, a device's vendor may expose aggregation(s) and/or grouping(s) of components that are in power dependencies, thereby allowing for optimization of energy consumption by the device. This can be further improved via introduction of the concept of Energy Consumption Point (ECP). An ECP is an embodiment optimized for a power consumptions aspect, grouping at least one component and/or at least one ECP. Vendors can use ECPs to provide power dependencies between components or between components and HW element(s) in their equipment through aggregations of components related to such HW element(s) in a model without showing exact HW element(s) in this model. Components that are in power saving dependency belong to the same ECP.

In an example, an ECP aggregates one or more components of device. An ECP may be assumed to consume maximum energy when all its components are configured and perform their corresponding function(s). If a component of ECP does not perform its function, the device may autonomously execute additional power saving function(s) by switching HW element(s) related to this component into an energy saving mode.

The concept of energy consumption point provides a possibility for a device to inform the user about such dependencies in a unified way, without a need to describe the HW element(s). The ECP, as a potential aggregation of components, may also provide supplementary information about energy and power consumption and power saving of the ECP as well as ECP states.

An ECP may also provide a control interface allowing consolidated power management for components grouped/aggregated by the ECP. Such interface, when used, may impact the state of all components within ECP.

Now that an ECP has been defined, usage of ECP is described. Knowing how components are grouped in ECPs, a user may configure its services so that in case user wants to put services into power saving mode, some components of specific ECP would be disabled/not used, giving the device the possibility to reduce power consumption within ECP by switching related HW element(s) to an energy saving mode.

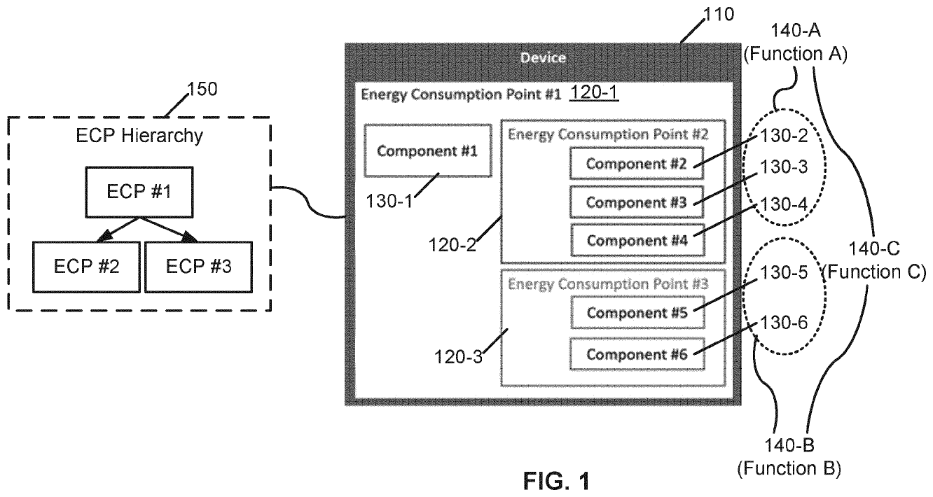

As one example, a vendor (e.g., a manufacturer selling a device) may decide to introduce three ECPs 120 within a device composed of six components 130 as presented in FIG. 1. In this example, device 110 has ECP #1 120-1, ECP #2 120-2, and ECP #3 120-3. The ECP 120-1 includes component #1 130-1 and ECPs #2 120-2 and #3 120-3. ECP #2 120-2 includes components #2 130-2, #3 130-3, and #4 130-4. ECP #3 120-3 includes components #5 130-5 and #6 130-6.

Configurability aspects of ECPs are now described. By indicating existence of three ECPs 120, as shown in FIG. 1, a vendor may inform the user that to optimize energy consumption and allow for the best possible energy preservation, configuration of the device should use, e.g., components #2 130-2, #3 130-3, and #4 130-4 to serve for function A 140-A, whilst components #5 130-5 and #6 130-6 should be configured to serve for function B 140-B. In such a configuration, at the time when one of those functions is not needed and the corresponding components do not need to perform operations, a corresponding ECP can achieve maximum power reduction. Optimized energy preservation might not be possible, if function A 140-A (and function B 140-B alike) was using components aggregated under different ECPs 120. It is noted that each function A 140-A and B 140-B correspond to one ECP #2 120-2 or #3 120-3, respectively, in this example, although the user may only know the functions relate to components 130. It is possible that a function, say function C, could correspond to multiple ECPs 120 (or functions 140), although a user may only know the functions correspond to components or to another function. For example, function C 140-C may include both functions A 140-A and B 140-B.

With respect to visibility aspects, consider the following. By indicating existence of ECP(s), a device also may also provide a user with visibility of dependencies between components and feasible energy saving. In the example of FIG. 1, a user would clearly see that disabling components #4 and #5 would not provide the most effective power saving, because there are still other running components in respective ECP #2 120-2 and ECP #3 120-3.

It is also possible to have hierarchical ECPs. That is, the exemplary embodiments herein permit, but do not force, the ability to have nested ECPs. This is illustrated in FIG. 1, where there is an ECP hierarchy 150 where ECP #2 and ECP #3 are nested under (or within) ECP #1. Many other options are possible, including multiple nesting, (e.g., ECP #3 could be next under ECP #2, which could be nested under ECP #1).

An ECP is proposed, in an exemplary embodiment, to be visible, e.g., as a component of the device and reported together with other components in the model. This means that an ECP can be aggregated within other ECPs. It is assumed that a parent ECP in a hierarchy 150 will offer the maximum power saving only in case all its children ECPs are already offering the maximum power saving.

In the example depicted in FIG. 1, particularly the hierarchy 150, ECP #1 120-1 is a parent for ECP #2 120-2 and ECP #3 120-3. Also, ECP #3 120-3 and ECP #2 120-2 are children of (and nested under) ECP #1 120-1.

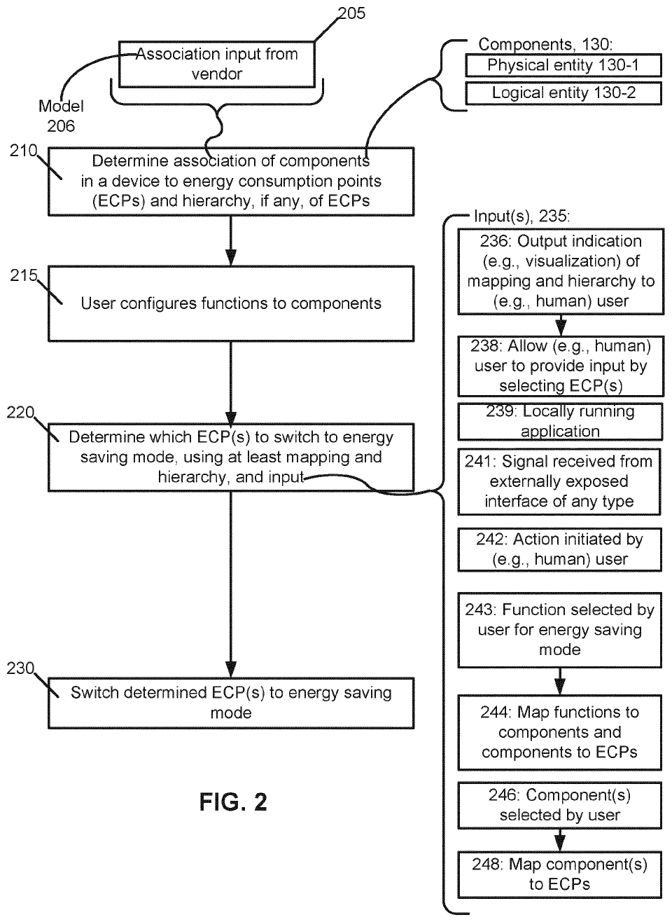

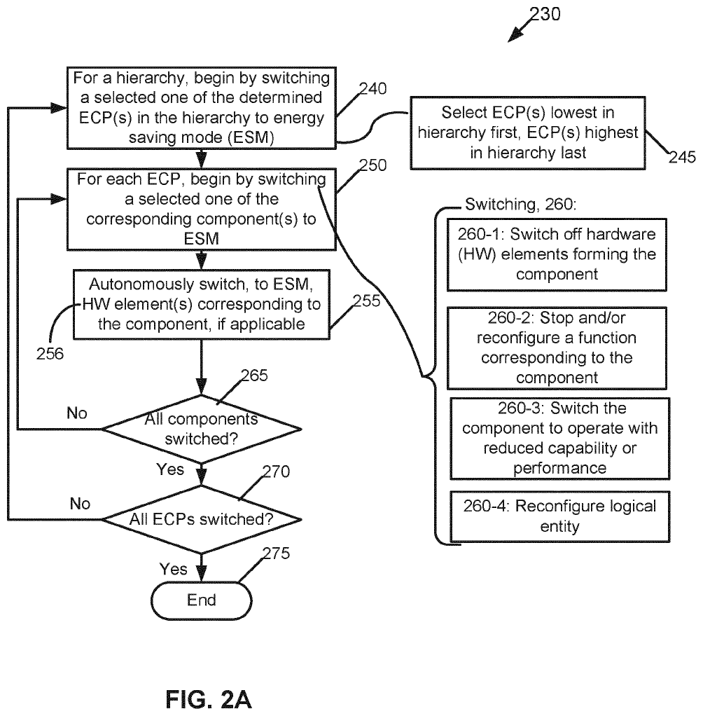

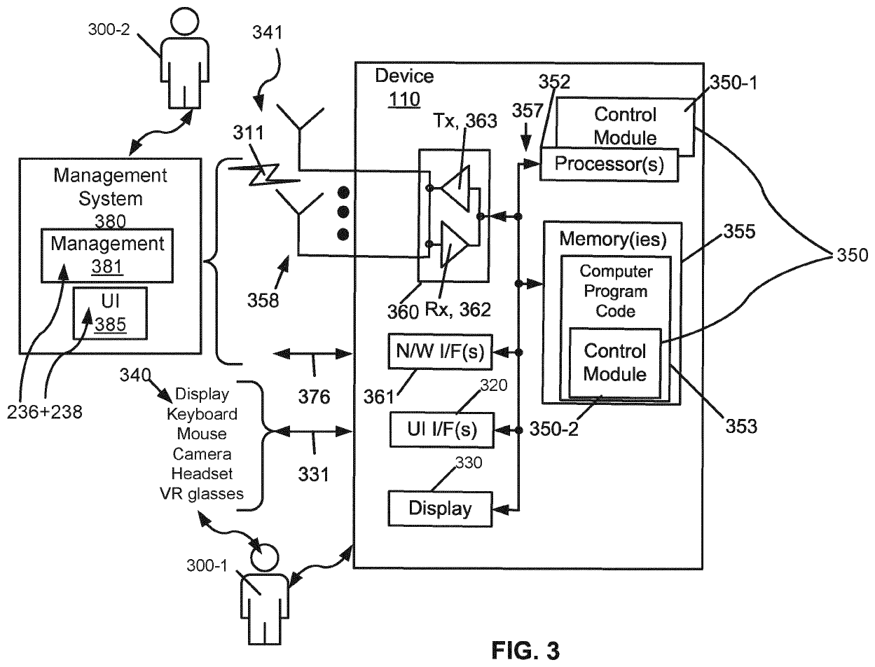

Turning to FIG. 2, this figure is a logic flow diagram for defining and using energy consumption points. This figure also illustrates the operation of an exemplary method or methods, a result of execution of computer program instructions embodied on a computer readable memory, functions performed by logic implemented in hardware, and/or interconnected means for performing functions in accordance with exemplary embodiments. The actions in this example are performed by the device 110. The device 110 may be under control of a control module 350 (see FIG. 3).

In block 210, the device 110 determines association of components 130 in a device to energy consumption points (ECPs) and hierarchy, if any, of ECPs 120. It is assumed that this association in block 210 is determined using association input from a vendor of the device 110, see block 205. The association is related to underlaying HW architecture, which is known to vendor and is not subject to change by external factors. The association input could be a model 206 that indicates association of components to ECPs (and ECPs to other ECPs). The association in the model 206 may be performed by a mapping from ECPs 120 to components 130. The components 130 may include a physical entity 130-1, such as a transceiver, or a logical entity 130-2, such as a higher-level entity (e.g., scheduling) that includes the transceiver.

Block 215 is applicable to some embodiments. In a model for these embodiments, a user configures functions 140 to component 130s. Components are the ones in this example that have actual capability of serving the functions. ECPs, as such, do not have this capability in this example, and instead provide information on which components have a common HW platform which consumes the power. This basically provides a mapping as to how components are related to device structure and power consumption.

The focus may therefore be placed on components and moving components to an energy saving mode. Thus, when a certain function 140 is no longer required, then related components are moved to energy saving modes. If those components happen to belong to a same ECP, then the device may also decide to shut down the ECP and some of the underlaying (and not visible to the user) elements of HW platform to reduce the energy consumption even more. A starting point, however, is the fact that a certain function and therefore service of certain components are not needed.

In block 220, the device 110 determines which ECPs 120 to switch to energy saving mode, using at least the mapping and the hierarchy 150, and input(s) 235. The input 235 may be provided by the following technique. In block 236, the device 110 outputs indication (e.g., displays a visualization) of the mapping and hierarchy to a user. In block 238, the device 110 allows the user to provide input by selecting one or more ECPs. While a “user” can be a human, other examples are envisioned too. In further detail, a “user” is an entity that decides about the switch. That is, a “user” can be any source that triggers switching, as described more below. Other inputs 235 may include the following: a locally running (e.g., running on the device 110) application 239, a signal received from an externally exposed interface of any type 241, or an action initiated by a user 242. For reference 242, this could be a human that is able to influence a state of the device, or an entity that is able to influence a state of the device.

For actions performed or initiated by a human, in general this would be person that is able to influence device's state, e.g., by being able to trigger switching of an energy consumption point into the associated energy savings mode. This could be via a physical action of a person (a user) on the device 110 (e.g., as in blocks 236 and 238, or block 242), but rather could also be via an action a person initiates through a remote (via another device) or local (via the device 110) management system (e.g., block 241, possibly a result of running blocks 236 and 238 on the management system). So technically all actions could utilize some interface to influence the device. What would be the trigger for the action requested via an interface could be human-requested or machine-requested.

In another example, which is applicable to block 215, consider the following. Of a possible important concern for the user are functions (e.g., A, B, C) which a device can provide to that user. The function might be e.g.: providing coverage and service by mobile network in certain area. This function may be a main business for the user and reason why the user interacts with the device. The starting point for this example for the entire power saving use case is that users might not need a certain function anymore (or just temporarily). A user intends to, and can afford to, “switch of” or “de-configure” or “stop” or “pause” the function, whatever describes this configuring. For this, a function is selected by user for energy saving mode, in block 243. This could be performed via any interface a user can use to select something, such as a displayed user interface or a signal internally or from a management system, as further described herein. The device 110 maps (block 244) functions to components and then to ECPs. More specifically, functions selected by a user in step 243 are mapped to components, based on configuration provided in block 215 and then those identified components are mapped to ECPs based on associations defined in block 210.

If an ECP 120 is indicated, then this would be mapped. For example, if the function A 140-A in FIG. 1 is indicated as being used for energy savings mode (such as no longer being needed or is to be shut down), then the components 130-2, 130-2, and 130-4 and, based on these components, the ECP 120-2, can be put into energy saving modes. In another example, it could be that a function (not shown in FIG. 1) is associated with component #1 130-1, and that component could be placed into an energy saving mode.

Another example is illustrated where one or more components 130 are selected by the user, block 246, and the device 110 can map these to ECPs 120, block 248.

That is, block 248 can include mapping component(s) selected by the user in block 246 to ECPs based on associations defined in block 210.

Block 246 could be performed via any interface a user can use to select something, such as a displayed user interface or a signal internally or from a management system, as further described herein. If the component can be mapped (block 248) to an ECP and the ECP can be placed in an energy saving mode, then the device 110 can do so. For example, if a user selects component #1 130-1 in FIG. 1, but all other components have to be active, then even though component #1 130-1 maps to ECP 120-1, the device will keep ECP 120-1 in an active mode, although place the component #1 130-1 in an energy saving mode. As another example, one or more components 130-2, 130-3, or 130-4 can be selected by a user. Depending on how many are selected and their relationship the device 110 might also place the ECP #1 120-2 into its energy saving mode. This is particularly true if the ECP #2 120-2 is associated with the function A 140-A, and this function is not active.

The relationship between how many or which components 130 need to be selected for the entire ECP 120 to be put into an energy saving mode may be predetermined, e.g., by the vendor using the model 206 or other association input in block 205. For example, the vendor could indicate the ECP 120-2 can be placed into its energy saving mode on one of the following: any component 130-2, 130-3 or 130-4 for ECP 120-2 in FIG. 1 is selected; if more than one but less than all components are selected; if specific component(s) is/are selected; or if all the components are selected.

These examples illustrate that the techniques herein do not force for selection of components rather than ECPs. Instead, both ways are permitted. That is, smart switching of components may provide a similar or the same benefit as switching of ECPs.

Switching whole ECPs may sometimes be “too destructive” for services. SW may be deployed to components rather than to ECPs, so control at the level of ECP offers benefits that pay back in terms of flexibility for use cases. So, both techniques may be useful: switching ECPs, but also switching atomic components. Additionally, smartly deployed applications could benefit from information about how components are grouped to ECPs by device vendor, allowing a trade-off between power consumption and service performance (which is not always needed at highest possible level).

In block 230, the device 110 switches the determined ECP(s) to energy saving mode. One example for this technique is illustrated by blocks 240-275, which are illustrated in FIG. 2A.

In block 240, the device 110 begins by switching a selected one of the determined ECP(s) in the hierarchy to energy saving mode (ESM). The device 110, in block 250, for each ECP, begins by switching a selected one of the corresponding component(s) to the ESM for that component. Examples of switching 260 are as follows, which could include one or more of the following:
260-1: Switch off hardware (HW) elements forming the component;
260-2: Stop and/or reconfigure a function corresponding to the component;
260-3: Switch the component to operate with reduced capability and/or performance.
260-4: Reconfigure a logical entity.

For stopping and/or reconfiguring a function 260-2, consider a software (SW) function, such as scheduler SW. The function of the SW program may be stopped, i.e., the SW is no longer performing the function, e.g., all cells are removed from being scheduled by the scheduler SW. As for reconfiguring this function, the scheduler SW could be reconfigured so that it only schedules some of the cells it can schedule.

For switching the component to operate with reduced capability and/or performance 260-3, an example is disabling multithreading on a processor, resulting in reduced processing capability (and also performance) of this processor.

For 260-4, reconfiguring a logical entity, consider that a customer could use a logical entity referred to as “pre-heating”. This is a logical entity that occasionally and conditionally uses physical heaters. This logical entity could be reconfigured to be switched to energy saving mode, which could result in, e.g., shortening pre-heating time or switching off pre-heating completely.

As previously described, it is possible for the device 110 to autonomously switch (block 255), to ESM, HW element(s) 256 corresponding to the selected component, if applicable. For instance, if the component is a transceiver and the transceiver has a power supply that can be switched to an ESM, such as an off state, the device 110 would switch the power supply (which could be part of a larger power supply) to the off state in block 255.

That is, the HW element(s) being autonomously switched are associated with a component, but not part of the component itself, and the device 110 makes a determination to switch these HW components 256 to an ESM.

For both the components 130 and HW elements 256, an energy saving mode is a state of a component or HW element but may be any mode that is a reduced-energy consumption as compared to when the component or element is running at full power, with full processing capability.

In block 265, the device determines whether all components have switched for the selected ECP. If not (block 265=No), the method proceeds back to block 250, where another component 130 in the ECP is selected. If so (block 265=Yes), in block 270, the device 110 determines whether all ECPs have been switched. If not (block 270=No), the flow proceeds to block 240, where another ECP in the hierarchy is selected. If so (block 270=Yes), the flow proceeds to block 275, where this technique ends.

While FIG. 2 provides no direction as to which ECP in a hierarchy could be placed into ECP in what order, it is possible for this to be implemented. In block 245, the device 110 could select ECP(s) lowest in hierarchy first, ECP(s) highest in hierarchy last. For instance, in the example of FIG. 1, either of ECPs #2 120-2 or #3 120-3 may be selected, then switched to an ECM, then the other of ECPs #2 120-2 or #3 120-3 may be selected, then switched to an ECM. The final selection is to ECP #1 120-2.

FIG. 2 does not show exit from the energy saving mode. However, the ECP(s) exit from energy saving mode is assumed to be triggered by a user (e.g., via a user interface, management interface or the like, either by a human or other entity). One of x (where x>1) components switched back to “fully operational mode” means that other components of the same ECP remain in energy saving mode. However, the benefit is energy not taken by other components still remaining in energy saving mode at the moment. The beneficial part of energy consumption (e.g., caused by switched off a power supply or part of such supply) is no longer preserved (e.g., because enabling component x required power supply to be enabled too).

Referring to FIG. 3, this figure is a block diagram of an apparatus in which the exemplary embodiments may be practiced. The device 110 includes circuitry comprising one or more processors 352, one or more memories 355, one or more network interfaces (N/W I/F(s)) 361, one or more user interface (UI) interface(s) 320, and one or more transceivers 360 interconnected through one or more buses 357. This example also includes a display 330 as part of the device 110. Each of the one or more transceivers 360 includes a receiver, Rx, 362 and a transmitter, Tx, 363. The one or more transceivers 360 are connected to one or more antennas 358 and the device communicates with other devices via an RF link 311. The one or more memories 355 include computer program code 353.

The device 110 includes a control module 350, comprising one of or both parts 350-1 and/or 350-2, which may be implemented in a number of ways. The control module 350 may be implemented in hardware as control module 350-1, such as being implemented as part of the one or more processors 352. The control module 350-1 may be implemented also as an integrated circuit or through other hardware such as a programmable gate array. In another example, the control module 350 may be implemented as control module 350-2, which is implemented as computer program code 353 and is executed by the one or more processors 352. For instance, the one or more memories 355 and the computer program code 353 are configured to, with the one or more processors 352, cause the device 110 to perform one or more of the operations as described herein, e.g., in FIG. 2.

The UI I/F(s) 320 comprise circuitry to allow a human user 300-1 to interface with the device 110, such as a display 330. In this example, the display 330 is internal to device 110, such as the device being a smartphone. The display could alternatively (or additionally) be separate from the device 110, such as being one of a number of UI input devices 340, including one or more of the following: a display; a keyboard; a mouse; a camera, a headset; or VR (virtual reality) glasses. The human user 300-1 could also or alternatively interface with the device 110 using the UI input devices 340. The UI I/F(s) 320 is/are connected to the UI input devices 340 via link(s) 331, which could be wired or wireless.

The N/W I/F(s) communicate via link(s) 376, which could be hardwired such as USB (universal serial bus), Ethernet, or optical. The N/W I/F(s) could implement, as an example, local area network communications, or communications with a cellular network.

In other examples, a human user 300-2 uses a management system 380 that has a user interface (UI) 385 on it. The actions for blocks 236 and 238 may be run on the UI 385, which would allow a display (block 236 of FIG. 2) of a visualization of mapping and hierarchy be presented to a human user, who would provide (block 238 of FIG. 2) input as to which ECP(s) are to be put into energy saving mode, e.g., possibly with a schedule, delay from an entry time, time period to remain in the energy saving mode, or the like. As another example, the output visualization of mapping and hierarchy in block 236 of FIG. 2 could be submitted to management software 381, which might control multiple devices 110. The output would be in a format the management software 381 understands, and the management software 381 could provide input as to which ECP(s) should be placed into energy saving mode, e.g., possibly with a schedule, delay from an entry time, time period to remain in the energy saving mode, or the like. The providing of the input could cause a signal 341 to be sent from the management system 380 to the device 110, and operated on as per block 241 and 220. The signal 341 could be sent via the RF link 311 or the wired link 376.

Without in any way limiting the scope, interpretation, or application of the claims appearing below, technical effects and advantages include the following. The concept of EPC allows a vendor to provide a user with information on how to use the equipment in most efficient way from an energy consumption point of view and yet without revealing any underlying HW structure of the device. Imagine the following scenario from the Open Radio Access Network (O-RAN) environment. An Open-Radio Unit (O-RU) reports existence of 16 identical components. A user wants to configure four cells, where each cell needs to use four components. Assume the HW of the O-RU comprises of one CPU (central processing unit) with four cores, where each core servers four specific components. Without the examples herein, a user will see 16 components available and will randomly assign cells to components. As the result, the four cells will be randomly spread between cores of the CPU. In such a deployment, if one cell is switched off, the CPU will most likely still operate with four cores. With the embodiments here, a vendor may report existence of four ECPs, where each ECP contains four components belonging to one core. A user may use this information to configure one cell in each ECP, which effectively means, to one core. This way, if during the runtime a cell is disabled (e.g.: not needed due to low load in the network), the entire core is not used and can be switched off, reducing the energy consumption of the CPU and device. Without the exemplary embodiments herein, the chance that cells are allocated to cores in an optimum way is via a purely random manner. Consequently, a benefit to the user is a possibility to configure and manage the device (e.g., O-RU) in energy-efficient way. Another benefit to the user is that in a multi-vendor environment (like O-RAN, where each O-RU may be from a different vendor), a user does not have to follow the vendor-specific configuration rules but operates on unified and standardized concept of ECP. An exemplary benefit to the vendor is that the HW architecture (1 CPU with 4 cores) is not revealed to the user.

One exemplary use case for devices 110 includes devices needed to serve a UE (such as cellular network infrastructure, e.g., base station transceiver units, remote radio heads, distributed units, and the like). This is only one of many uses, however. The concept could aim at any other combination of hardware (HW)/software (SW), such as processing units, baseband blocks, SW components, which are not necessarily related to cellular networks.

The following are additional examples.

Example 1. A method, comprising:

determining a mapping from one or more of multiple components in a device to an energy consumption point;

performing one or both of the following:

in response to input indicating one or more components of the energy consumption point is to be placed into energy saving mode, switching autonomously by the device the energy consumption point into an associated energy saving mode for additional energy saving gain relative to only if the one or more components are switched into energy saving modes, the switching autonomously based at least on the mapping; or
in response to input indicating the energy consumption point should be placed into an energy saving mode, switching by the device individual ones of the determined one or more components into associated energy saving modes.

Example 2. The method according to example 1, wherein the switching autonomously further comprises switching autonomously by the device elements, associated with the determined one or more components but not part of the determined one or more components, into associated energy saving modes for additional energy saving gain relative to only switching the one or more components into corresponding energy saving modes.

Example 3. The method according to examples 1 or 2, wherein the switching individual ones of the determined one or more components into associated energy saving modes comprises one or more of the following:

switching off hardware elements forming the individual component;

stopping a function corresponding to the individual component or reconfiguring the function;

switching the individual component to operate with reduced capability or performance or both reduced capability and performance; or
reconfiguring a logical entity corresponding to the individual component.

Example 4. The method according to one of examples 1 to 3, the switching autonomously further comprises for at least one of the one or more components, switching autonomously one or more hardware elements corresponding to the at least one component into an energy saving mode for those one or more hardware elements.

Example 5. The method according to one of examples 1 to 4, wherein there are multiple energy consumption points and wherein the determining the mapping from the one or more of the plurality of components to the energy consumption point is performed for all of the multiple energy consumption points.

Example 6. The method according to example 5, wherein the multiple energy consumption points are formed into a hierarchy having parent points and child points, wherein one or more child energy consumption points are nested under a parent energy consumption point.

Example 7. The method according to one of examples 1 to 6, wherein the mapping is defined by a vendor of the device.

Example 8. The method according to one of examples 1 to 7, wherein the input indicating the energy consumption point is to be placed into energy saving mode or the input indicating the energy consumption point should be placed into an energy saving mode comes from a user.

Example 9. The method according to example 8, further comprising:

output indication of a hierarchy, comprising one or both of the one or more components or multiple energy consumption points, to the user, and

receiving input from the user based on the output indication.

Example 10. The method according to one of examples 1 to 9, wherein the input indicating the energy consumption point is to be placed into energy saving mode or the input indicating the energy consumption point should be placed into an energy saving mode comes from an application running on the device, a signal received by the device from an externally exposed interface of any type, or an action initiated by a user.

Example 11. The method according to one of examples 1 to 10, wherein:

there are multiple components for the energy consumption point, one or more of the multiple components is indicated in the input;

the method further comprises:

mapping the multiple components to the energy consumption point;

performing the switching the components indicated in the input to the energy saving mode and even though not all of the multiple components are indicated in the input; and

performing the autonomous switching of the individual ones of the determined one or more energy consumption points, even though not all of the multiple components of individual energy consumption point are indicated in the input.

Example 12. The method according to one of examples 1 to 11, wherein:

the input indicating a function selected by a user for energy saving mode, the function corresponding to the one or more components; and

the method further comprises:

mapping the function to the one or more components to determine the one or more components that are to be placed into associated energy saving modes;

mapping the determined one or more components to the one or more energy consumption points;

performing the switching autonomously based on the mapping the determined one or more components to the one or more energy consumption points; and

performing the switching individual ones of the determined one or more components into associated energy saving modes based on the determined one or more components that are to be placed into associated energy saving mode.

Example 13. A computer program, comprising code for performing the methods of any of examples 1 to 12, when the computer program is run on a computer.

Example 14. The computer program according to example 13, wherein the computer program is a computer program product comprising a computer-readable medium bearing computer program code embodied therein for use with the computer.

Example 15. The computer program according to example 13, wherein the computer program is directly loadable into an internal memory of the computer.

Example 16. An apparatus, comprising means for performing:

determining a mapping from one or more of multiple components in a device to an energy consumption point;

performing one or both of the following:

in response to input indicating one or more components of the energy consumption point is to be placed into energy saving mode, switching autonomously by the device the energy consumption point into an associated energy saving mode for additional energy saving gain relative to only if the one or more components are switched into energy saving modes, the switching autonomously based at least on the mapping; or

in response to input indicating the energy consumption point should be placed into an energy saving mode, switching by the device individual ones of the determined one or more components into associated energy saving modes.

Example 17. The apparatus according to example 16, wherein the switching autonomously further comprises switching autonomously by the device elements, associated with the determined one or more components but not part of the determined one or more components, into associated energy saving modes for additional energy saving gain relative to only switching the one or more components into corresponding energy saving modes.

Example 18. The apparatus according to examples 16 or 17, wherein the switching individual ones of the determined one or more components into associated energy saving modes comprises one or more of the following:

switching off hardware elements forming the individual component;

stopping a function corresponding to the individual component or reconfiguring the function;

switching the individual component to operate with reduced capability or performance or both reduced capability and performance; or

reconfiguring a logical entity corresponding to the individual component.

Example 19. The apparatus according to one of examples 16 to 18, the switching autonomously further comprises for at least one of the one or more components, switching autonomously one or more hardware elements corresponding to the at least one component into an energy saving mode for those one or more hardware elements.

Example 20. The apparatus according to one of examples 16 to 19, wherein there are multiple energy consumption points and wherein the determining the mapping from the one or more of the plurality of components to the energy consumption point is performed for all of the multiple energy consumption points.

Example 21. The apparatus according to example 20, wherein the multiple energy consumption points are formed into a hierarchy having parent points and child points, wherein one or more child energy consumption points are nested under a parent energy consumption point.

Example 22. The apparatus according to one of examples 16 to 21, wherein the mapping is defined by a vendor of the device.

Example 23. The apparatus according to one of examples 16 to 22, wherein the input indicating the energy consumption point is to be placed into energy saving mode or the input indicating the energy consumption point should be placed into an energy saving mode comes from a user.

Example 24. The apparatus according to example 23, wherein the means are further configured to perform:

output indication of a hierarchy, comprising one or both of the one or more components or multiple energy consumption points, to the user, and

receiving input from the user based on the output indication.

Example 25. The apparatus according to one of examples 16 to 24, wherein the input indicating the energy consumption point is to be placed into energy saving mode or the input indicating the energy consumption point should be placed into an energy saving mode comes from an application running on the device, a signal received by the device from an externally exposed interface of any type, or an action initiated by a user.

Example 26. The apparatus according to one of examples 16 to 25, wherein:

there are multiple components for the energy consumption point, one or more of the multiple components is indicated in the input;

the means are further configured to perform:

mapping the multiple components to the energy consumption point;

performing the switching the components indicated in the input to the energy saving mode and even though not all of the multiple components are indicated in the input; and

performing the autonomous switching of the individual ones of the determined one or more energy consumption points, even though not all of the multiple components of individual energy consumption point are indicated in the input.

Example 27. The apparatus according to one of examples 16 to 26, wherein:

the input indicating a function selected by a user for energy saving mode, the function corresponding to the one or more components; and

the means are further configured to perform:

mapping the function to the one or more components to determine the one or more components that are to be placed into associated energy saving modes;

mapping the determined one or more components to the one or more energy consumption points;

performing the switching autonomously based on the mapping the determined one or more components to the one or more energy consumption points; and

performing the switching individual ones of the determined one or more components into associated energy saving modes based on the determined one or more components that are to be placed into associated energy saving mode.

Example 28. The apparatus according to any preceding apparatus example, wherein the means comprises:

at least one processor; and

at least one memory including computer program code, the at least one memory and computer program code configured to, with the at least one processor, cause the performance of the apparatus.

Example 29. An apparatus, comprising:

one or more processors; and

one or more memories including computer program code,

wherein the one or more memories and the computer program code are configured, with the one or more processors, to cause the apparatus to:

determining a mapping from one or more of multiple components in a device to an energy consumption point;

performing one or both of the following:

in response to input indicating one or more components of the energy consumption point is to be placed into energy saving mode, switching autonomously by the device the energy consumption point into an associated energy saving mode for additional energy saving gain relative to only if the one or more components are switched into energy saving modes, the switching autonomously based at least on the mapping; or

in response to input indicating the energy consumption point should be placed into an energy saving mode, switching by the device individual ones of the determined one or more components into associated energy saving modes.

Example 30. The apparatus according to example 29, wherein the one or more memories and the computer program code are configured, with the one or more processors, to cause the apparatus to perform methods in any one of examples 2 to 12.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 3. A computer-readable medium may comprise a computer-readable storage medium (e.g., memories 355 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments of the invention, these descriptions should not be viewed in a limiting sense. Rather, there are several variations and modifications which may be made without departing from the scope of the present invention.

1. A method, comprising:
determining a mapping from one or more of multiple components in a device to an energy consumption point; and
performing one or both of the following:
in response to input indicating one or more components of the energy consumption point is to be placed into energy saving mode, switching autonomously with the device the energy consumption point into an associated energy saving mode for additional energy saving gain relative to only if the one or more components are switched into energy saving modes, the switching autonomously based at least on the mapping; or
in response to input indicating the energy consumption point should be placed into an energy saving mode, switching with the device individual ones of the determined one or more components into associated energy saving modes.

2. The method according to claim 1, wherein the switching autonomously further comprises switching autonomously with the device elements, associated with the determined one or more components but not part of the determined one or more components, into associated energy saving modes for additional energy saving gain relative to only switching the one or more components into corresponding energy saving modes.

3. The method according to claim 1, wherein the switching individual ones of the determined one or more components into associated energy saving modes comprises one or more of the following:
switching off hardware elements forming the individual component;
stopping a function corresponding to the individual component or reconfiguring the function;
switching the individual component to operate with reduced capability or performance or both reduced capability and performance; or
reconfiguring a logical entity corresponding to the individual component.

4. The method according to claim 1, wherein the switching autonomously further comprises for at least one of the one or more components, switching autonomously one or more hardware elements corresponding to the at least one component into an energy saving mode for those one or more hardware elements.

5. The method according to claim 1, wherein there are multiple energy consumption points and wherein the determining the mapping from the one or more of the plurality of components to the energy consumption point is performed for the multiple energy consumption points.

6. The method according to claim 5, wherein the multiple energy consumption points are formed into a hierarchy having parent points and child points, wherein one or more child energy consumption points are nested under a parent energy consumption point.

7. The method according to claim 1, wherein the mapping is defined with a vendor of the device.

8. The method according to claim 1, wherein the input indicating the energy consumption point is to be placed into energy saving mode or the input indicating the energy consumption point should be placed into an energy saving mode comes from a user.

9. The method according to claim 8, further comprising:
output indication of a hierarchy, comprising one or both of the one or more components or multiple energy consumption points, to the user, and
receiving input from the user based on the output indication.

10. The method according to claim 1, wherein the input indicating the energy consumption point is to be placed into energy saving mode or the input indicating the energy consumption point should be placed into an energy saving mode comes from an application running on the device, a signal received with the device from an externally exposed interface of any type, or an action initiated with a user.

11. The method according to claim 1, wherein:
there are multiple components for the energy consumption point, one or more of the multiple components is indicated in the input;
the method further comprises:
mapping the multiple components to the energy consumption point;
performing the switching the components indicated in the input to the energy saving mode and even though not all of the multiple components are indicated in the input; and
performing the autonomous switching of the individual ones of the determined one or more energy consumption points, even though not all of the multiple components of individual energy consumption point are indicated in the input.

12. The method according to claim 1, wherein:
the input indicating a function is selected with a user for energy saving mode, the function corresponding to the one or more components; and
the method further comprises:
mapping the function to the one or more components to determine the one or more components that are to be placed into associated energy saving modes;
mapping the determined one or more components to the one or more energy consumption points;
performing the switching autonomously based on the mapping the determined one or more components to the one or more energy consumption points; and
performing the switching individual ones of the determined one or more components into associated energy saving modes based on the determined one or more components that are to be placed into associated energy saving mode.

13. (canceled)

14. (canceled)

15. (canceled)

16. An apparatus, comprising
at least one processor; and
at least one memory storing instructions that, when executed with the at least one processor, cause the apparatus to perform at least:
determining a mapping from one or more of multiple components in a device to an energy consumption point; and
performing one or both of the following:
in response to input indicating one or more components of the energy consumption point is to be placed into energy saving mode, switching autonomously with the device the energy consumption point into an associated energy saving mode for additional energy saving gain relative to only if the one or more components are switched into energy saving modes, the switching autonomously based at least on the mapping; or
in response to input indicating the energy consumption point should be placed into an energy saving mode, switching with the device individual ones of the determined one or more components into associated energy saving modes.

17. The apparatus according to claim 16, wherein the instructions, when executed with the at least one processor, cause the apparatus to perform switching autonomously with the device elements, associated with the determined one or more components but not part of the determined one or more components, into associated energy saving modes for additional energy saving gain relative to only switching the one or more components into corresponding energy saving modes.

18. The apparatus according to claim 16, wherein the instructions, when executed with the at least one processor, cause the apparatus to perform one or more of the following:
switching off hardware elements forming the individual component;
stopping a function corresponding to the individual component or reconfiguring the function;
switching the individual component to operate with reduced capability or performance or both reduced capability and performance; or
reconfiguring a logical entity corresponding to the individual component.

19. The apparatus according to claim 16, wherein the instructions, when executed with the at least one processor, cause the apparatus to perform, for at least one of the one or more components, switching autonomously one or more hardware elements corresponding to the at least one component into an energy saving mode for those one or more hardware elements.

20. The apparatus according to claim 16, wherein there are multiple energy consumption points and wherein the instructions, when executed with the at least one processor, cause the apparatus to perform determining the mapping from the one or more of the plurality of components to the energy consumption point for all of the multiple energy consumption points.

21. The apparatus according to claim 20, wherein the instructions, when executed with the at least one processor, form the multiple energy consumption points into a hierarchy having parent points and child points, wherein one or more child energy consumption points are nested under a parent energy consumption point.

22. The apparatus according to claim 16, wherein the instructions, when executed with the at least one processor, cause the apparatus to define the mapping with a vendor of the device.

23. The apparatus according to claim 16, wherein the input indicating the energy consumption point is to be placed into energy saving mode or the input indicating the energy consumption point should be placed into an energy saving mode comes from a user.

24. The apparatus according to claim 23, wherein the instructions, when executed with the at least one processor, cause the apparatus to perform:
output indication of a hierarchy, comprising one or both of the one or more components or multiple energy consumption points, to the user, and
receiving input from the user based on the output indication.

25. The apparatus according to claim 16, wherein the input indicating the energy consumption point is to be placed into energy saving mode or the input indicating the energy consumption point should be placed into an energy saving mode comes from an application running on the device, a signal received with the device from an externally exposed interface of any type, or an action initiated with a user.

26. The apparatus according to claim 16, wherein:
there are multiple components for the energy consumption point, one or more of the multiple components is indicated in the input; and
the instructions, when executed with the at least one processor, further cause the apparatus to perform:
mapping the multiple components to the energy consumption point;
performing the switching the components indicated in the input to the energy saving mode and even though not all of the multiple components are indicated in the input; and
performing the autonomous switching of the individual ones of the determined one or more energy consumption points, even though not all of the multiple components of individual energy consumption point are indicated in the input.

27. The apparatus according to claim 16, wherein:
the input indicating a function is selected with a user for energy saving mode, the function corresponding to the one or more components; and
the instructions, when executed with the at least one processor, cause the apparatus to perform:
mapping the function to the one or more components to determine the one or more components that are to be placed into associated energy saving modes;
mapping the determined one or more components to the one or more energy consumption points;
performing the switching autonomously based on the mapping the determined one or more components to the one or more energy consumption points; and
performing the switching individual ones of the determined one or more components into associated energy saving modes based on the determined one or more components that are to be placed into associated energy saving mode.

28. (canceled)

29. (canceled)

30. (canceled)

31. A non-transitory program storage device readable with an apparatus, tangibly embodying a program of instructions executable with the apparatus to cause the apparatus to perform at least:
determining a mapping from one or more of multiple components in a device to an energy consumption point; and
performing one or both of the following:
in response to input indicating one or more components of the energy consumption point is to be placed into energy saving mode, switching autonomously with the device the energy consumption point into an associated energy saving mode for additional energy saving gain relative to only if the one or more components are switched into energy saving modes, the switching autonomously based at least on the mapping; or in response to input indicating the energy consumption point should be placed into an energy saving mode, switching with the device individual ones of the determined one or more components into associated energy saving modes.
